(19) United States
(12) Patent Application Publication
(10) Pub. No.: US 2023/0286557 A1
(43) Pub. Date: Sep. 14, 2023

(54) DIAGNOSTIC INSPECTION SYSTEM FOR INSPECTING RAILWAY COMPONENTS

(71) Applicant: TESMEC S.P.A., Milano (IT)

(72) Inventors: Silvestro Di Gioia, Bitetto (BA) (IT); Gianluca Fumarola, Bitetto (BA) (IT)

(21) Appl. No.: 18/015,389

(22) PCT Filed: Jul. 8, 2021
(86) PCT No.: PCT/IB2021/056145

§ 371 Date: Jan. 10, 2023

(30) Foreign Application Priority Data
Jul. 15, 2020 (IT) 102020000017197

(51) Int. Cl. B61L 23/04; G01C 22/00; G01N 21/95; B61K 9/10; H04N 23/90

(52) U.S. Cl. CPC B61L 23/045; G01C 22/00; G01N 21/95; B61K 9/10; H04N 23/90; B61L 2205/04; H04N 23/56

(57) ABSTRACT

A diagnostic inspection system for inspecting railway components which can be mounted on a railway vehicle designed to travel on a railway track, said diagnostic inspection system being designed to perform a diagnostic inspection of a railway component during movement on the railway track, said diagnostic inspection system comprising: one single mechanical structure (10) which can be fixed below the body of a railway vehicle; first optical units (13) positioned on said mechanical structure (10) for a first rail (11); second optical units (14) positioned on said mechanical structure (10) for a second rail (12); each of said optical units (13, 14) comprises: a matrix camera (20) associated with an infrared laser (21), and a linear camera (22) associated with a white laser (RGB) (23); said white laser (RGB) (23) comprises: three laser sources capable of emitting the three primary colours; three dichroic mirrors able to sum the components of said three laser sources in one single point; a Powell lens to generate a white light line; said first optical units (13) comprise a first left-hand optical unit positioned externally to said first rail (11) and inclined to frame the outer side of said first rail (11), a first central optical unit positioned perpendicular above said first rail (11) and a first right-hand optical unit positioned externally to said first rail (11) and inclined to frame the inner side of said first rail (11); said second optical units (14) comprise a second left-hand optical unit positioned internally to said second rail (12) and inclined to frame the inner side of said second rail (12), a second central optical unit positioned perpendicular above said second rail (12) and a second right-hand optical unit positioned externally to said second rail (12) and inclined to frame the outer side of said second rail (12); said mechanical structure (10) is a bar having a length greater than the distance between said first rail (11) and said second rail (12).

The present invention refers to a diagnostic inspection system which can be mounted on a railway vehicle designed to travel on a railway track. The diagnostic inspection system in accordance with the present invention is designed to perform a diagnostic inspection of several railway components during movement on the railway track.

In the railway transport sector, the maintenance of railway track components in appropriate conditions is of fundamental importance.

The railway track conditions significantly affect the safety and reliability of railway transport.

The failure or deterioration of various railway components of a railway track can cause derailment of the train.

To verify the behaviour of the railway components, checks are carried out on: geometry of the track, rail profile measurement, track equipment (points) geometry measurement, and on the track bed in order to detect any defects.

The object of the present invention is to provide an integrated diagnostic inspection system which allows several controls at the same time.

A further object is to provide a diagnostic inspection system that allows inspection of the railway components during travel on the railway track.

A further object is to provide a diagnostic inspection system that allows rapid inspection of the railway components, at a speed of 140 km/h.

In accordance with the present invention, said objects and others still are achieved by a diagnostic inspection system of railway components in accordance with claim 1.

Further characteristics of the invention are described in the dependent claims.

This solution has many advantages compared to the solutions of the known art.

The diagnostic inspection system, in accordance with the present invention, is able to integrate a measurement system for measuring the track geometry, a measurement system for measuring the entire rail profile, a measurement system for measuring the track equipment (points) geometry and a video inspection system for inspecting the track bed in order to detect any defects, in one single mechanical structure to be fixed below the body of the railway vehicle and on which all the electronics and diagnostic devices scheduled for integration of the above-mentioned four systems are fixed.

Up to seven optical measurement units and an inertial platform are installed inside the mechanical structure.

Each optical measurement unit comprises a matrix camera and infrared laser which define a laser triangulation optical subsystem able to define the profilometry of the scene of the track framed, and a linear camera and a white laser (RGB) for video reconstruction, in colour, of the scene of the track bed framed.

The characteristics and advantages of the present invention will become evident from the following detailed description of a practical embodiment thereof, illustrated by way of non-limiting example in the attached drawings, in which:

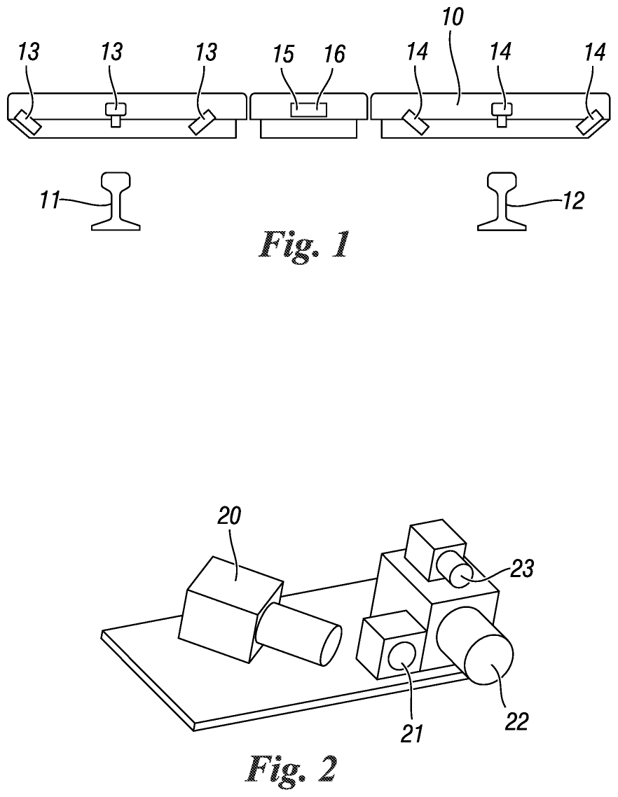

FIG. 1 shows schematically a mechanical structure of a diagnostic inspection system, in accordance with the present invention;

FIG. 2 shows schematically an optical unit of a diagnostic inspection system, in accordance with the present invention;

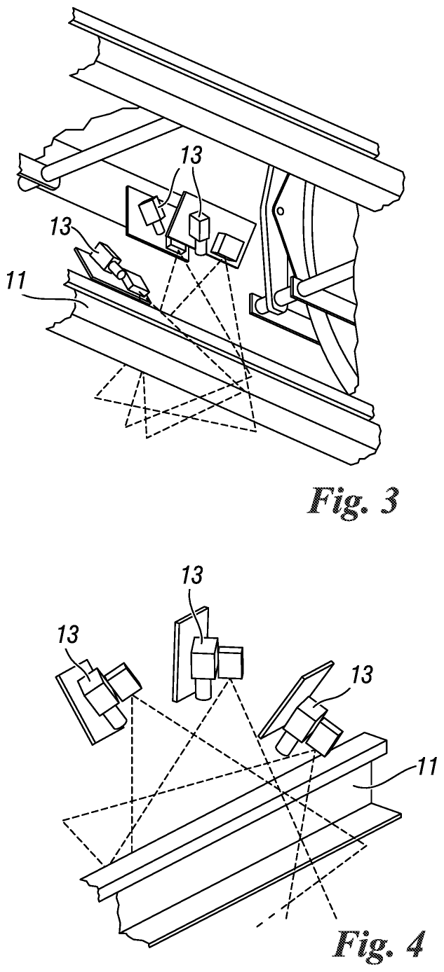

FIG. 3 shows schematically an example of location of the optical units for a track, positioned on a railway vehicle, of a diagnostic inspection system, in accordance with the present invention;

FIG. 4 shows schematically an example of location of the optical units for a track, of a diagnostic inspection system, in accordance with the present invention.

Referring to the attached figures, the diagnostic inspection system, in accordance with the present invention, comprises one single mechanical structure 10 to be fixed below the body of a railway vehicle and on which the scheduled diagnostic devices and associated electronics are fixed.

The mechanical structure 10 is a bar having a length greater than the distance between the two rails 11 and 12.

On the mechanical structure 10 three optical units 13 are positioned for the rail 11 and three optical units 14 for the other rail 12 and, preferably, an optical unit 15 positioned centrally to the two rails 11 and 12, and an inertial platform 16.

The three optical units 13 and 14 are fixed to the mechanical structure 10 so that one optical unit is positioned perpendicular above the rail 11 or 12, and the other two optical units are fixed to the mechanical structure 10, laterally to the rails 11 or 12, so that they view the rail 11 or 12 at an angle of 45°, one to frame the outer side of the respective rail and one to frame the inner side of the respective rail. The combination of the images of the three optical units, for each track, allows complete vision of the rail profile.

Each of the optical units 13, 14 and 15 comprises a matrix camera 20 associated with an infrared laser 21, and a linear camera 22 associated with a white laser (RGB) 23 for the video reconstruction, in colour, of the scene of the track bed framed.

The matrix camera 20 and the infrared laser 21 define a laser triangulation optical subsystem able to define the profilometry of the scene of the track framed. They therefore allow measurement of the track geometry with the aid of an inertial platform 16, the entire profile of the rail and the geometry of the track equipment.

The matrix camera 20 and the infrared laser 21 allow a triangulation to be performed derived from the position of the laser, camera and object to be analysed, which form a triangle. A configuration of a 3D detection system provides an infrared laser 21 used to project a beam onto the object to be analysed.

The profile illuminated by the laser is then captured with a CCD (Charge-Coupled Device) sensor. Laser and sensor must be positioned at a known and fixed distance.

By means of trigonometric relations it is possible to determine the coordinates (x, y, z) of the points constituting the surface of the object.

At the mechanical design stage the baseline b is defined, namely the distance between laser and optical centre of the camera in which the reference system x, y, z is positioned.

The theta angle is also fixed (formed between axis x and laser plane) and the focal length of the lens.

The projection of a 3d point (x, y, z) will appear on the sensor with coordinates (x′, y′) where

x′=line*dimension pixel [mm]

y′=column*dimension pixel [mm]

Once the values of x′ and y′ are known, it is possible, by means of trigonometric equations, to solve the system for determination of the three spatial coordinates.

To illuminate the object to be analysed, point lasers can be used but it is preferable to use line lasers to illuminate several points simultaneously, thus significantly speeding up the acquisition process. Scanners that exploit triangulation can cover distances in the order of a few meters, therefore much less than time-of-flight scanners. However, high precision can be obtained in the measurement, in the order of a few dozen micrometres. They are also very inexpensive, since a camera and a laser are sufficient; this fact also makes them easily reconfigurable if required, thus adapting to the type of surface to be analysed. The main defect of this method is the possible presence of shaded areas in the images obtained. According to the ambient conditions (interference of sunlight) and the characteristics of the object to be analysed (very oblique or reflecting surfaces, presence of grooves or slits) the laser beam may not be able to reach all the points of interest.

To limit this drawback it is necessary to position laser and camera as close as possible, in this case accepting a reduction in precision.

The construction of a 3D scanner requires an accurate knowledge of the geometry of the lens of the camera used to capture the images that will be subsequently analysed. The main parameter of a lens is its focal distance (or focal length). The camera lens projects only a part of the scene into the sensor. The visual field is determined by two angles that depend on the focal distance and the dimensions of the projection plane.

The information necessary for determination of the coordinates (x, y, z) of the surface of an object are therefore: laser position, angle of inclination of the laser relative to the camera, position of the camera focus, lens focal distance, dimensions and resolution of the CCD sensor.

With these data available it is possible to define the equation of the plane on which the laser beam lies and of the lines connecting the points of the profile in the image plane to the camera focus. The intersection of the two determines the position of the object in three-dimensional space.

The linear camera 22 and the white laser (RGB) 23 allow, by means of computer vision algorithms and AI algorithms to be applied to colour images, recognition along the track bed of the defects in the rail head, defects in the ballast, defects and cracks in the sleepers, defects and cracks in the rail fastenings and defects in the rail joints.

The combined use of a linear camera 22 and a white laser 23 allows the acquisition of very high-resolution colour images of the track bed.

More specifically, the linear camera 22 is formed of sensors positioned on one single line. In short, it develops an image with one single line of pixels. When an image has to be reconstructed, it is done with the object to be viewed in movement. In this case the image is reconstructed through the composition of several lines acquired at a fixed distance from one another. The spatial interval with which the single lines are acquired is determined with the aid of an encoder.

The object is scanned by passing it under the lens, thus obtaining a high resolution which will permit optimal reconstruction. This characteristic is of fundamental importance when defect checking has to be carried out on all the mechanical parts lying along the track bed.

The illumination of the white laser (RGB) 23 for this type of video inspection is obtained by combining three tiny laser sources able to emit the three primary colours (red, blue and green); by collimating the rays thereof by means of a lens, it is possible to obtain white and potentially, by modulating the various components, obtain the emission of any colour with extreme precision. By using a high-power highly collimated white light, it is possible to guarantee perfect illumination of the line of colour pixels constituting the linear camera.

Since a very fine white laser line has to be created with collimation systems, it is necessary to have a coherent light, this being a characteristic of lasers and not of white leds or white lights.

The defects present on the rail, and those relative to the entire supporting infrastructure, require not only a profilometric analysis and therefore dimensional measurement, which guarantees the right correlation with the construction geometry and design parameters. In fact, some defects require a visual analysis, therefore control of an image at very high resolution which best represents the possible defect that can occur on the rail, on the ballast or on any one of the members composing the infrastructure. For this purpose it is furthermore necessary, in order to avoid false positives, not only to have a very high resolution but also a colour image.

The defects are identified by analysing the image obtained by the camera by means of computer vision algorithms, AI algorithms and by trying to extract information that characterizes the defect.

Thanks to the use of three lasers, one red, one blue and one green, to obtain the white laser 23, and the adoption of three dichroic mirrors able to “sum” the components of the three sources in one single point, it is possible to have a white light spot with high intensity since it is highly collimated. The use of a Powell lens allows a line to be generated from the single point. This line is on the same focal plane as the linear camera.

Technology today makes it possible to have linear cameras with very high resolution and with sampling frequencies higher than ten or so kilohertz. Reconstruction of the image from the linear cameras therefore occurs by acquiring images relative to a given measurement section and at distances of one millimetre from one another. The section relative to the left-hand rail acquires a line with very high resolution (over 6000 points per line) in colour. The same operation is performed by the right-hand one. The process is perfectly synchronous. As the vehicle moves, it starts the subsequent scanning process at millimetre pitch dictated by an odometry system and relative generation of synchronisms, present in the inertial platform 16.

The odometry system is a system formed of a quadrature encoder, a board for acquisition and generation of electric signals, a high-precision GPS and a PC.

The encoder, mechanically connected to the wheel, generates pulses by rotation. These pulses are in a fixed number for each complete rotation of the wheel. Once the diameter of the wheel and the number of encoder pulses are known, it is possible to calculate the distance travelled by the rolling stock and the speed thereof. It is also possible to generate synchronism signals to be sent to the systems of interest at a given spatial frequency by means of the signal generation board. A high-precision GPS associates with the calculated movement datum the relative geodetic coordinate, and determines the position in which the image has been captured. All the data are then saved by a designated PC.

A software reconstructs an image which will no longer be a single line, but a matrix line, therefore with a fixed resolution in the direction y (direction transverse to the track), and equal to the space travelled divided into millimetres in the direction of travel.

The optical unit 15 positioned centrally to the two rails 11 and 12 is not strictly required. It is installed if it is necessary to measure or view any defects in the centre of the rails such as, for example, cracks in the centre of a sleeper, detection of incorrectly assembled signalling buoy, lack of ballast etc.

A processing device receives the signals of various optical units and from the inertial platform, acquires them, processes them with computer vision programs and determines the defects.

The diagnostic inspection system thus conceived is subject to numerous modifications and variations, all falling within the scope of the inventive concept; furthermore, all the details can be replaced by technically equivalent elements.

1. A diagnostic inspection system for inspecting railway components which can be mounted on a railway vehicle designed to travel on a railway track, said diagnostic inspection system being designed to perform a diagnostic inspection of a railway component during movement on the railway track, said diagnostic inspection system comprising: one single mechanical structure (10) which can be fixed below the body of a railway vehicle; first optical units (13) positioned on said mechanical structure (10) for a first rail (11); second optical units (14) positioned on said mechanical structure (10) for a second rail (12); each of said optical units (13, 14) comprises: a matrix camera (20) associated with an infrared laser (21), and a linear camera (22) associated with a white laser (RGB) (23); said white laser (RGB) (23) comprises: three laser sources capable of emitting the three primary colours; three dichroic mirrors able to sum the components of said three laser sources in one single point; a Powell lens to generate a white light line; said first optical units (13) comprise a first left-hand optical unit positioned externally to said first rail (11) and inclined to frame the outer side of said first rail (11), a first central optical unit positioned perpendicular above said first rail (11) and a first right-hand optical unit positioned externally to said first rail (11) and inclined to frame the inner side of said first rail (11); said second optical units (14) comprise a second left-hand optical unit positioned internally to said second rail (12) and inclined to frame the inner side of said second rail (12), a second central optical unit positioned perpendicular above said second rail (12) and a second right-hand optical unit positioned externally to said second rail (12) and inclined to frame the outer side of said second rail (12); said mechanical structure (10) is a bar having a length greater than the distance between said first rail (11) and said second rail (12).

2. The system according to claim 1 characterized in that said linear camera (22) is formed of sensors positioned on one line only.

3. The system according to claim 1 characterized in that it comprises a third optical unit (15) positioned centrally relative to said first rail (11) and to said second rail (12).

4. The system according to claim 1 characterized in that it comprises an inertial platform (16) which comprises an odometry system and a synchronism generator.

5. The system according to claim 4 characterized in that said odometry system comprises a quadrature encoder, a board for acquisition and generation of electric signals, a GPS and a PC.

6. The system according to claim 5 characterized in that said encoder is mechanically connected to a wheel of said railway vehicle to allow calculation of the distance travelled and the speed of said railway vehicle.

7. The system according to claim 4 characterized in that said inertial platform comprises a GPS for determining the position of said railway vehicle.
